(19) United States
(12) Patent Application Publication
(10) Pub. No.: US 2003/0154005 A1
(43) Pub. Date: Aug. 14, 2003

(54) System for measuring and adjusting pitch and roll in a suspension

(75) Inventors: Sow Long Wong, Singapore (SG); Yi Quiang Yang, Shanghai (CN); Choong Wee Hong, Kangar (MY)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: ATS Automation Tooling Systems Inc.

(21) Appl. No.: 10/286,745

(22) Filed: Nov. 1, 2002

Related U.S. Application Data
(60) Provisional application No. 60/330,893, filed on Nov. 2, 2001.

(51) Int. Cl. G05B 15/02

(52) U.S. Cl. 700/279; 29/402.21; 29/705

(57) ABSTRACT

The invention relates to an apparatus and method for measuring and adjusting the pitch and roll angle in the suspension head for magnetic readers for disk drives. The system includes a linear advancement system, a measurement system, an adjustment and heat treatment system and control algorithms TO measure, adjust and correct the roll and pitch in a suspension head.

### FIELD OF THE INVENTION

The invention relates to a system and method for measuring and adjusting the pitch and roll angle in a suspension for magnetic readers for disk drives. The system includes a linear advancement system, a measurement system, an adjustment and heat treatment system and control algorithms to measure, adjust and correct the roll and pitch in a suspension.

### BACKGROUND OF THE INVENTION

Magnetic recording hard drives include components enabling data to be read from or written to a rotating magnetic disk. More specifically, hard drives utilize head gimbal assemblies (HGAs), also known as head suspension assemblies (HSAs) to support transducers (sliders) in close proximity to the rotating disk surfaces. As a result of the close proximity between the rotating disk surface and the slider, and the various parameters which affect the interaction between the slider and rotating disk surface, it is of tantamount importance that the alignment between the slider and rotating disk surface is precisely maintained within acceptable tolerances.

Collectively referred to herein as suspension head assemblies or suspensions, these devices include an air bearing head slider assembly mounted to a suspension system. The suspension system is made from separate parts including a mount plate, load beam and flexure having flexure arms as shown in FIGS. 1 and 1a. The slider (not shown) is configured to the flexure after the alignment of the flexure is determined to be within the desired tolerances. The alignment of the flexure with respect to the mount and hence the disk surface is set or controlled in two directions namely by setting or controlling the roll and pitch of the flexure arms with respect to the mount. These measurements are commonly referred to as the pitch static attitude (PSA) and the roll static attitude (RSA).

The PSA and RSA can be controlled to a certain de),re during the assembly of the suspension by proper selection of matching pans and by control of the laser fielding process generally used during assembly. However, after joining the parts of the suspension, the load beam section is bent to create a gram load, which in the final product will push the slider against the hard disk. This production step can create unpredictable changes in the PSA and RSA and accordingly, there continues to be a need to efficiently and effectively adjust the PSA and RSA for angles generated by the gram load process step.

Existing methods of adjusting the PSA and RSA include laser based methods, mechanical bending methods and process control improvements that obviate the need for adjustment.

For example, U.S. Pat. Nos. 5,832,764 and 6,011,239 describe laser based adjustment methods using an infrared laser to heat spots on the load beam region. The heat of the laser stress relieves the metal, which changes the spring constant of the loaded flexure and load beam regions and thus the PSA and RSA.

Mechanical bending methods on their own typically use a gripper or wedge-like feature to twist the flexure arms instead of the load beam. The main problem with this method of adjustment is the accessibility of the grippers to the flexure. More specifically, grippers require direct accessibility to the front end of a flexure in order to have a good grip to perform the twisting and bending and not all suspension designs allow this accessibility. Another problem with this method is that it does not allow both action of twisting and bending to be performed at the same time which may limit the adjustment algorithm applicable.

One solution to the use of grippers is the utilization of four needle probes which can be applied to the flexure at four separate locations and independently controlled to apply both twisting and bending required for PSA and RSA adjustment. One disadvantage of the needle probe method, however is that it is slower as it has more movement to complete for one adjustment.

Further still, in both needle and gripper adjustment machines, more than one adjustment may be required before achieving the desired PSA and RSA as a result of the cold working nature of mechanical bending. In order to have a permanent angle change, re-bending and over-bending is often required which takes longer to complete and which may result in angle drift over time after the adjustment.

Thus, there remains a requirement to be able to efficiently adjust suspension alignments to produce stable alignments. More specifically, there is a requirement for equipment and control systems which effectively measure, mechanically adjust and align suspension systems in an automated process using heat treatment.

### SUMMARY OF THE INVENTION

In accordance with the invention, there is provided a system for measuring and adjusting the roll and pitch angles of a suspension for a magnetic disk drive, the suspension having flexure arms, the system comprising:

a linear advancement sub-system for advancing successive suspensions to a measurement and adjustment position,

a measurement sub-system for determining the roll and pitch angle of the flexure arms;

an adjustment sub-system for mechanically bending the roll and pitch angles of the flexure arms to an aligned or over-aligned position; and,

a heat treatment sub-system for applying a heat treatment to the flexure arms when in the aligned or over-aligned position.

The system also preferably includes a control algorithm having a database of heat treatment parameters for instructing the beat treatment system to apply a specific heat treatment to the flexure arms in the aligned or over-aligned position where the control algorithm may select a specific heat treatment on the basis of measured roll and pitch angles.

In one embodiment, the adjustment system includes four needle probes for applying a bending force to the suspension to move the suspension to the aligned or over-aligned position. In another embodiment, the adjustment system includes four gripper arms for applying a bending force to the suspension to move the suspension to the aligned or over-aligned position.

In a preferred embodiment, the heat treatment system includes a laser that applies a heat treatment in the heat treatment zone according to predetermined laser parameters selected from length, width, laser power and time.

In accordance with another embodiment, the system provides a method of adjusting the roll and pitch angles of a suspension for a magnetic reader for a disk drive, the suspension having flexure arms comprising the steps of:

a) measuring the pitch and roll angle of the flexure arms,

b) determining if the measured pitch and roll angles of the flexures are within a predetermined specification;

c) ending the suspension to an adjusted position if the pitch and/or roll angle of the flexure arms is/are out of specification;

d) holding the flexure arms in the adjusted position and applying a heat treatment to the flexure arms to relieve bending stresses in the flexure arms; and,

e) holding the flexure arms in the adjusted position for a time sufficient to allow the flexure arms to cool.

### BRIEF DESCRIPTION OF THE DRAWINGS

FIG. 1 is a perspective view of a typical suspension in accordance with the prior an;

FIG. 1a is an underside schematic diagram of the distal end of a suspension showing details of the flexure and tongue in accordance with the prior art;

FIG. 2 is a schematic perspective diagram of the adjustment system of a pitch and roll adjustment machine (PRAM) in accordance with one embodiment of the invention,

FIG. 2a is a schematic perspective diagram of the measurement, adjustment and hear treatments of a PRAM with a suspension being adjusted in accordance with one embodiment of the invention;

FIG. 3 is a flow chart showing the measurement, alignment and heat treatment process in accordance with one embodiment of the invention;

FIG. 3A is a representative 3^{rd} order polynomial regression curve shown fitted to a raw data set of delta roll and probe displacement values;

FIG. 4 is a graphical representation of the measured and alignment positions of a suspension head for positive and negative roll and pitch; and,

FIG. 5 is a flow chart showing the communication between the laser, controlling computer, and pitch roll adjustment machine in accordance with one embodiment of the invention.

### DETAILED DESCRIPTION OF THE INVENTION

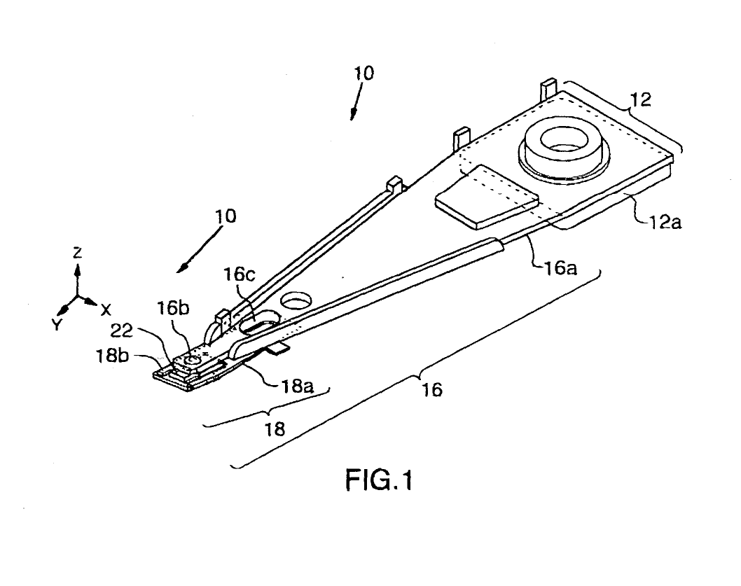

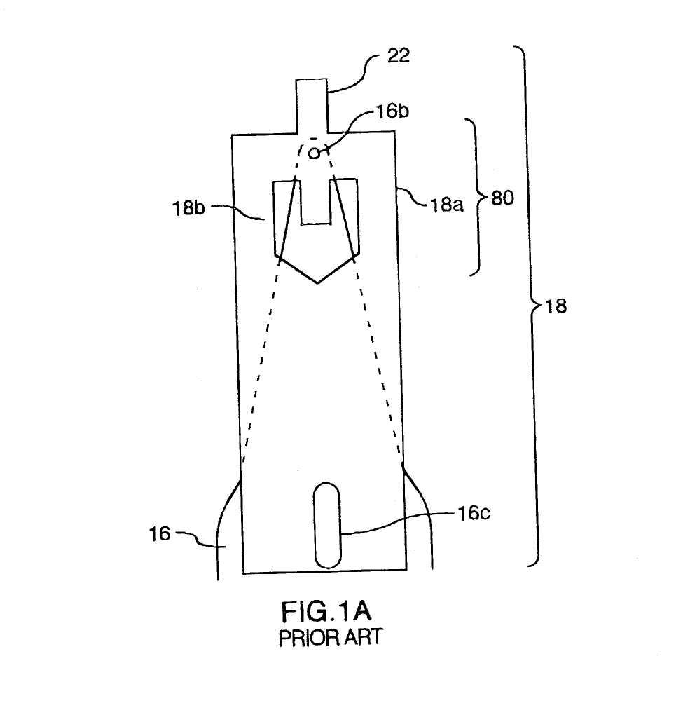

The design of a typical suspension 10 is shown schematically in FIGS. 1 and 1a.

A suspension 10 generally includes a mounting assembly 12, a central load beam 16 and a flexure assembly 18. The mounting assembly 12 includes a mount plate 12a that provides the attachment point of the suspension 10 to the arm of a hard drive. The central load beam 16 has a spring 16a for connecting the load beam 16 to the mount plate 12a and for providing a gram load force to keep a slider (not shown) against a magnetic disk (not shown). The flexure assembly 18 includes two flexure arms 18a, 1b and a tongue 22 in the center of the flexure region 18 for mounting a slider. The tongue 22 is at the distal end of flexure arms 18a, 18b and is parallel to the longitudinal axis of the central load beam. The flexure assembly 18 is mounted to and biased against the distal end of the central load beam 16 at connection 16c. The load beam 16 also includes a dimple 16b (a semi-spherical protrusion at the distal end of the load beam 16) that provides a gimbal mount for the slider to allow movement in the pitch and roll axes. All these parts are preferably made of stainless steel. The pitch static attitude (PSA) and roll static attitude (RSA) of a suspension are the pitch and Toll angles of the flexure arms relative to the mount plate 12.

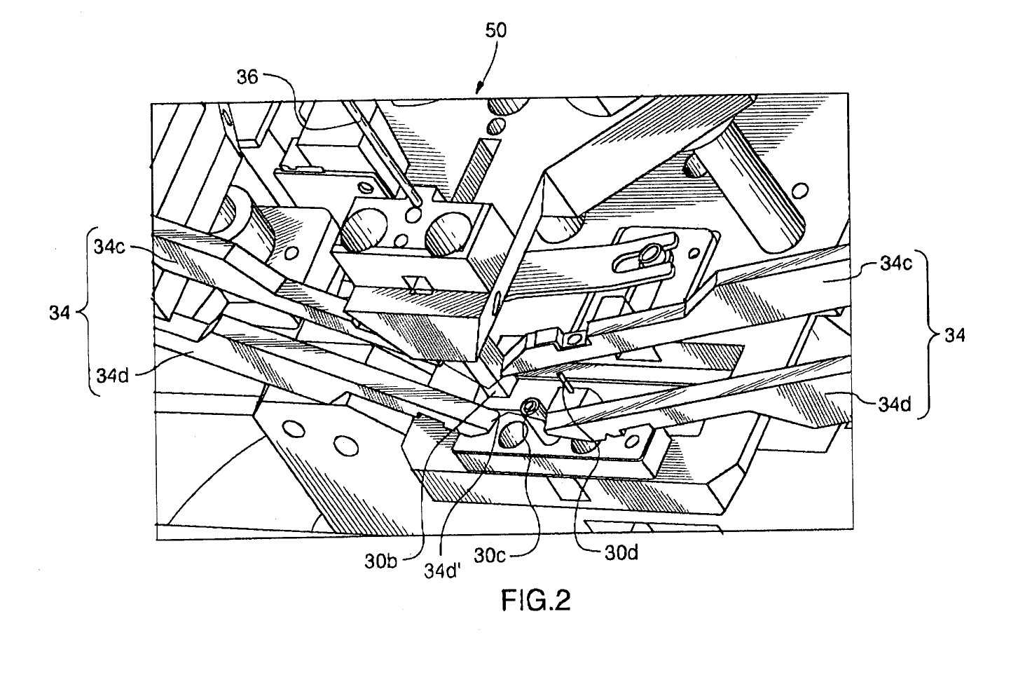

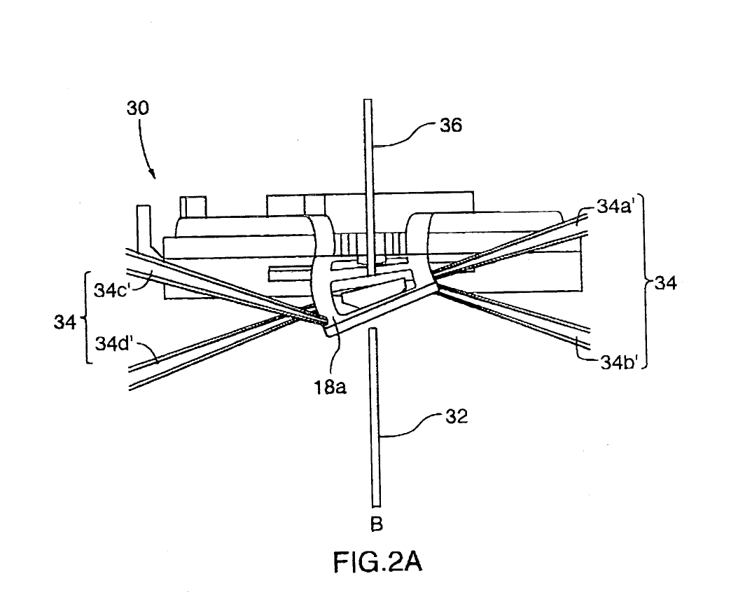

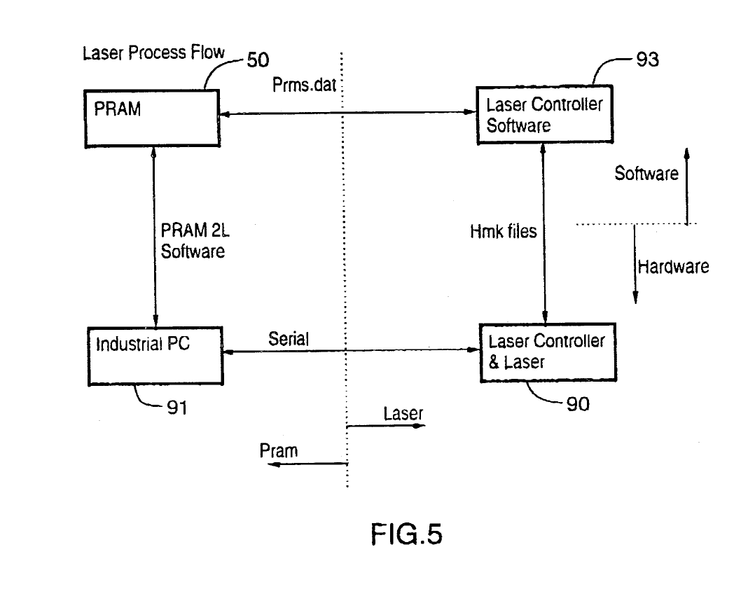

The pitch and roll adjustment machine (PRAM) 50 in accordance with the invention is a precision instrument used to automatically measure and adjust the pitch and roll angle of the flexure arms of a suspension prior to the assembly of the slider on the tongue 22. The PRAM as shown in FIGS. 2 and 2a generally includes a linear advancement system (not shown for clarity) for advancing an array of suspensions through the PRAM, a measurement system 32 for determining the misalignment of a suspension, an adjustment system 34 for adjusting the roll and pitch of a suspension, a laser heat treatment system 36 for hear fixing the adjustment of a suspension and system controllers and algorithms for control of the system, all of which are described in greater detail below. The system controllers and algorithms include the appropriate hardware and software enabling communication between the PRAM 50, a controlling PC 91, laser controller software 93 and a laser controller and laser 90 as shown in FIG. 5.

Linear Advancement System

In order to enable the automated processing of suspensions, multiple suspension heads are held in a linear advancement system. Individual suspensions are mounted to a loading plate or jig (not shown in FIGS. 2 and 2A for clarity) and are successively advanced towards and through a measurement and adjustment position B in the PRAM in a manner which is known in the art. That is, an array of suspension heads is sequentially advanced through the PRAM from 1) a pre-measurement/adjustment position A, to 2) a measurement/adjustment position B and to 3) a post-measurement/adjustment position C.

At the measurement/adjustment position B, the loading plate or jig is moved towards a datum pin 30b until the mount plate 12a of a suspension is near the datum pin 30b. A locator pin 30c rises from below to clamp the mount plate 12a of a suspension 10 against the datum pin 30b. A lifter pin 30d pushes the load beam to raise the flexure arms a specific amount depending on the specifications of the specific suspension. It is important to note that the lifter pin action is not a part of the adjustment method.

Measurement System 32

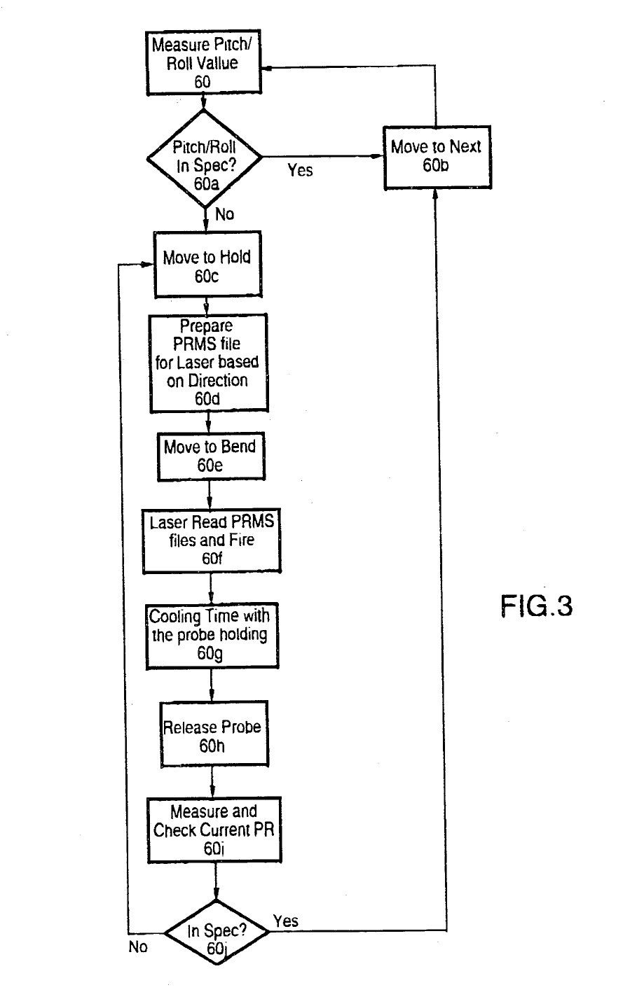

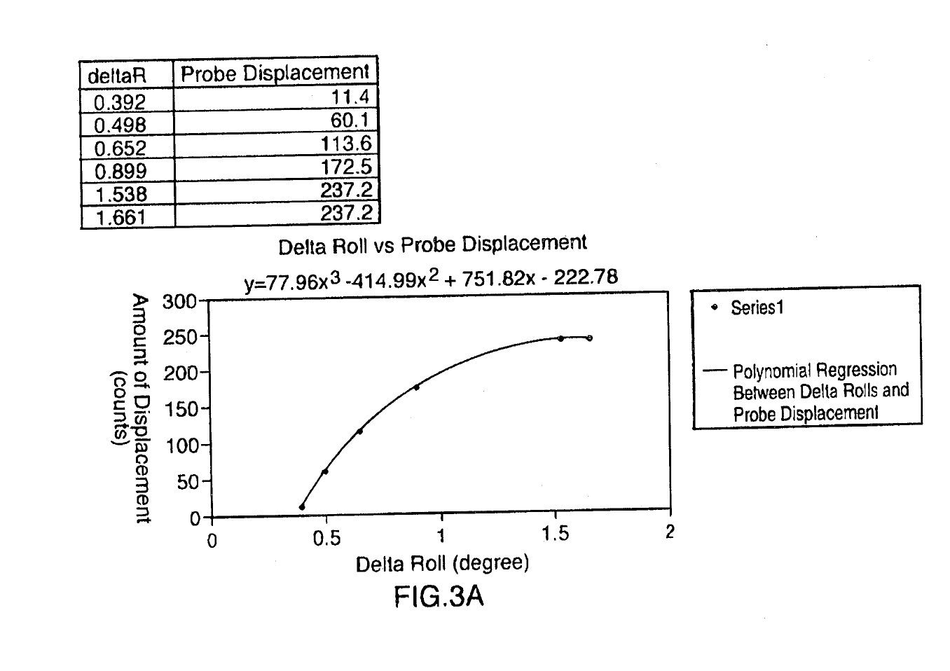

After clamping the mount plate of a suspension against the datum pin 30b, at the measurement and adjustment position B, and with reference to FIG. 3, a measurement system 32 measures the roll and pitch of the flexure arms of the suspension (Box 60) to determine if adjustment is necessary based on the relative degree of alignment or misalignment of each suspension.

Position sensors (not shown) measure the roll and pitch angles of the flexure arms to quantify the amount of flexure arm misalignment.

After determining the roll and pitch angle of the flexure arms, the system control algorithms (FIG. 3) determine if 1) the alignment is in specification which triggers moving to the next suspension (Box 60b), 2) the alignment is out of specification but within a tolerance range which can be corrected (Box 60c) or 3) the alignment is out of a tolerance for adjustment and will be rejected (Box 60b). Measured misalignment may be both positive and negative for both roll and pitch.

The measurement system is preferably an optical measuring device (preferably using reflective laser light) mounted in a location relative to the suspensions such that measurements can be done at any time during the adjustment process and that enables both roll and pitch to measured simultaneously.

Adjustment System 34

With reference to FIG. 3, if the measured angles are measured as being correctable, the adjustment system 34 is activated to adjust the roll and pitch angles into specification (Box 60c). The hold position is calculated based on the initial reading obtained at Box 60 and a database of hold position values described below. At Box 60c, the alignment arms 34a, 34b, 34c, 34d move to a preliminary position prior to contacting the suspension, at which time (Box 60d) a PRMS file is created which represents the heating pattern of the laser required for a given bend movement. The PRMS file will instruct the laser controller 93 through an appropriate communication link. Adjustment involves two main steps, bending or alignment (Box 60e) and heat treatment (Box 60f).

With reference to FIGS. 2a and 3, the adjustment system 34 advances upper and lower arms 34a-d having needles 34a′, 34b′, 34c′, 34d′ against the flexure arms 18a, 18b of the suspension to move and hold the suspension system in a corrected position for heat treatment (Box 60e). The alignment arms may be a gripper system or fine probes (including needle probes as shown in FIGS. 2 and 2A) which contact the flexure arms 18a at the contact positions from above and below to apply an alignment pressure opposite to the measured direction of misalignment. For example, in the event that a positive roll and pitch angle are measured, the alignment arms would apply a pressure in the negative direction to place the flexure arms within specification prior to heat treatment. It is important, as will be explained in greater detail below, that the alignment arms may overcompensate for misalignment. That is, and for the example of measured positive roll and pitch angles, the alignment arms may bias the flexure arms to a negative roll and pitch angle prior to heat treatment

Further still, the adjustment system preferably enables two bending steps termed overbend and backbend to be applied prior to heat treatment. Overbend bends the suspension release stress energy. At the point where the suspension begins to elastically yield, release of the overbend pressure (through heat treatment as detailed below) may result in a properly aligned suspension. However, as the proper alignment may not be realized from the overbend and heat treatment, backbend, which bends an overbent suspension back towards the zero position may be required to achieve a stable alignment where stress energy in the opposite direction is released.

Heat Treatment System 36

After the arms and needles are positioned to correct the alignment, laser heat treatment is applied in the treatment zone 80 (FIG. 1a) of one or both of the flexure arms 18a, 18b in order to relieve the stress applied by the alignment arms (Box 60f). The specific heating pattern applied will depend on the measured misalignment and will be selected from a database of heat treatment patterns.

After heat treatment, the alignment arms continue to hold the flexure arms (Box 60g) for a time to allow the arms to cool to room temperature before releasing the biasing forces. The holding time will typically be 0.5 s.

After laser treatment, the measurement system 32 releases the suspension (box 60h) and verifies the alignment (Box 60i) and re-aligns and retreats the suspension, if necessary (Box 60c-60i).

Control Algorithms

The control algorithms for the measurement 32, adjustment 34 and heat treatment 36 systems include databases of measurement, adjustment and heat treatment values for use in selecting appropriate adjustment and heat treatment patterns. Primarily, the actual measured misalignment values for a suspension are used to select specific adjustment and heat treatment parameters.

Measurement, Adjustment and Heat Treatment Algorithms

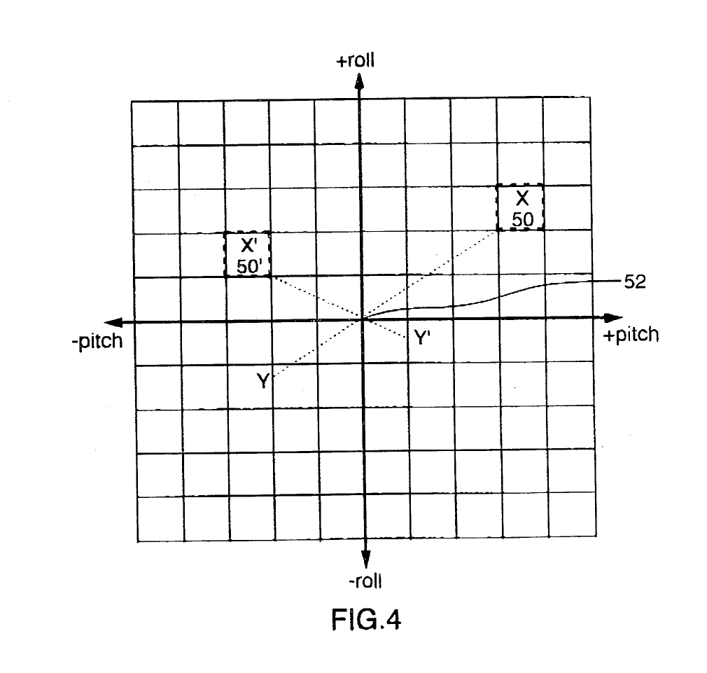

With reference to FIG. 4, the measurement system measures the value of roll and pitch angle misalignment, X for a particular suspension when it has been filly biased against the datum surface. When the linear advancement system signals that the suspension has been fully biased against the datum surface, the measurement algorithm obtains a measured value X. The measured value has a roll and pitch component, which may require pitch increase, pitch decrease, roll increase or roll decrease. In this example, both roll and pitch are positive.

The measurement system has a resolution that will define a discrete number of misalignment values within a particular range of anticipated misalignment values, thus defining a database of measurement values. For example, the tolerance range of misalignment values may be from +−2.2 degrees at a resolution of 0.2 degrees thereby defining 10 discrete values for each of the pitch and roll parameters or 100 discrete measurements for the combination. Thus, an actual misalignment value will be considered as a discrete value within the resolution of the measurement system as shown m FIG. 4 as box 50. More or less discrete values may be programmed into the measurement database depending on the resolution of the measurement system and/or the typical range of misalignment values for a particular type of suspension.

After obtaining a measured misalignment value, the alignment algorithm will determine the physical coordinates that the flexure arms 184 must be moved to prior to heat treatment based on the measured misalignment. Accordingly, for each discrete misalignment value, there is a corresponding set of physical coordinates for alignment. If the resolution of the alignment system corresponds to the resolution of the measurement, for each discrete measure misalignment value, there may be a corresponding alignment coordinate. However, if the resolution of each system is different, two or more values of measured misalignment may correspond to only one alignment coordinate.

The physical coordinates may be the zero position 52 or an overcompensated position, shown as position Y. As described above, overcompensation or overbend may be required to allow for a relaxing of the flexure arms towards the zero position 52 after heat treatment. A second measured value X′ may be aligned to position Y′ as shown in FIG. 4 prior to heat treatment.

The values of alignment coordinates within the alignment database for a given measured misalignment value is determined on the basis of trial and error for a given suspension design and heat treatment pattern. Different batches of the same suspension design may require modification of the alignment and heat treatment databases. Generally, for higher measured misalignment values, a higher overcompensation may be required. Under most circumstances, however, overcompensation and backbend are not required

Furthermore, depending on the measured values, the system will determine primary and secondary adjustment parameters to determine the manner in which the needles 34a′-34d′ contact the flexure arms 18a. For example, the system will select one of four types of adjustment, PSA increase, PSA decrease, RSA increase or RSA decrease based on the measured values (Box 60) in order to determine whether to hold the bottom or top of the flexure. If both the PSA and PSA are to be simultaneously adjusted, a primary adjustment is selected. If the primary adjustment is ±PSA, the secondary is ±RSA and vice versa.

After determining the primary adjustment (for example +RSA), the system obtains the corresponding primary adjustment data from a database for ±RSA which has been previously generated from a 3^{rd} order polynomial curve fit of measured +RSA values and experimentally determined hold positions for those +RSA values. Other data sets may be utilized depending on the particulars of the set-up including whether the particular adjustment is an overbend or backbend adjustment. The secondary adjustment is similar using data generated from another polynomial curve fit.

Experimentally, it has been determined that a 3^{rd} order polynomial curve fit for the primary adjustment and a 2^{nd} order polynomial curve fit for the secondary adjustment provides desirable results without slowing down the operation of the PRAM as a result of processing times required by the control algorithm. In particular, a 3^{rd} order polynomial curve fit demonstrates a good relationship between the measured misalignment and the probe displacement of the adjustment system.

For example, a 3^{rd} order polynomial curve for each of +RSA, −RSA, +PSA and PSA is obtained by performing a polynomial regression (3^{rd} order regression type) curve fit between the probe displacement of the adjustment system for a given suspension versus the measured misalignment value (delta) for pitch or Troll from at least 6 data points. The range of delta is preferably in the range from 0 to 12 degrees for most suspensions.

From the equation of a polynomial curve,

y=±Ax³+Bx²+Cx±D

where A, B, C, and D are the fit parameters determined from the regression analysis, y is the amount to bend and x refers to the measured pitch or roll delta. With reference to FIG. 3A, a fitted 3^{rd} order polynomial regression curve is shown fitted to a raw data set of delta roll and probe displacement using Microsoft Excel.

Similarly, a second order polynomial regression curve is obtained for the secondary adjustment by repeating the above steps with historical data wherein 3 fit parameters are obtained.

It is also understood that other fitting algorithms may be employed as determined by those skilled in the art.

Furthermore, for suspensions where heat treatment is required, additional heat treatment parameters are required to determine the location and intensity of the heat treatment. In one embodiment, it is preferred that the location of heat treatment on the flexure arms 18a, 18b (zone 80) is sub-divided into regions (for example, 6 regions). Heat treatment parameters for each region may include varying the laser power and number of laser pulses as well as the upper and lower limits or positions of the laser contact within each region. Laser power and number of laser pulses are the set power of the laser and number of pulse cycles for the region, respectively. The upper and lower limits are the coordinates of upper aid lower boundaries for each region.

As indicated, the laser heat treatment system applies a specific heat treatment to the flexure arms in the treatment zone determined on the basis of trial and error. In various embodiments of the invention and depending on the particular characteristics of the heat treatment system, the heat treatment parameters may involve selection of time, area, pattern (orientation), scanning speed, number of passes, laser power and the position of the laser at firing as described below.

Area—The area for heat treatment on the flexure arm is defined by the laser beam width and the length of treatment. The beam width is typically fixed at 0.5 mm and the length will typically range from 1-2 mm.

Pattern—The heat treatment pattern or orientation may be varied to include single or parallel heat treatment zones which may be angled with respect to one another. Vertical or horizontal heat treatment patterns may be more appropriate for different adjustment coordinates.

Time, Number of Passes and Scanning Speed—The time of heat treatment may be varied to alter the time of heat treatment of the flexure arms. The heating time is typically 0.5 s which may vary depending on the number of passes and the scanning speed of the laser. The number of passes, that is the number of times the laser is fired at a given position, can be varied. Typically, passes may be varied between 3 and 10 passes. For example, a 3 kHz laser with a scanning speed of 80 mm/sec making 4 passes may be used determine the specific heating time over a given pattern.

Power—The power of the laser may be varied to alter the temperature applied to the flexure arms. The power is typically variable between 0.9 and 1.18 W depending on materials. Wire type materials (such as stainless steel) require higher power (1.1W-1.18W typical) whereas wireless type materials (suspensions comprising lamination layers of stainless steel, copper with gold coating or polymers as well as trace suspension assemblies (TSA) and flex-on suspensions (FOS)) require lower power (0.9-1.1W).

FIG. 5 shows a schematic overview of a communication protocol between the heat treatment laser and controller 90, the controlling computer 91, the PRAM 92 and the laser controller software 93. As shown, the PRAM 92 receives and sends instructions/data to both the controlling computer 91 and the laser controller software 93. The controlling computer 91 also sends and receives instructions/data to and from the laser controller and laser 90. The heat treatment laser also sends and receives instructions/data to and from the laser controller software 93.

In a preferred embodiment, HMK files are prepared by the laser controller software 93 where the user defines the laser firing parameters and is stored as a prms.dat file. Prms.dat files describe to the laser controller the characteristics and parameters to fire and may contain up to 13 parameters including pattern filename (HMK filename), object number to fire, number of pulses per activation, laser frequency, laser power, mark speed, end time, miscellaneous data to transfer while marking, length and height of pattern to fire, position in X and Y coordinates and degree of rotation of the pattern.

A serial connection between the laser controller 90 and computer 91 enables the transfer of prms.dat files from the computer 91 and laser controller 90.

The PRAM 2L software controls the PRAM 92 as described in FIG. 3.

Other Features

Other features may be incorporated in the control algorithms including “self-adjustment” algorithms which may modify either the alignment coordinates and/or heat treatment pattern based on past experience with a particular batch or type of suspension For example, if a specific batch of suspensions is being consistently treated and is consistently being re-measured with an out-of-spec roll or pitch parameter, the control algorithm may correct for this by more or less alignment compensation or more or less heat treatment.

More specifically, if each bending and/or heat treatment fails to adjust the suspension to the target pitch and roll, the degree of misalignment will be recorded in a log file. If the number of failures reach a preset number (within a certain resolution), the control algorithm may, based on the trend of the failures, update the database by increasing the laser power or increasing the amount of over-bending or back-bending displacement on the probe and reset the counter once it is updated.

Typical suspensions have specifications requiring pitch of 0 degrees ±0.2 degrees and 0 degrees roll ±0.2 degrees. In measuring and adjusting the roll and pitch of a particular type of suspension, the PRAM is initially set-up for the particular suspension type.

If there is no existing data for the adjustment/heat treatment database for the suspension type, data to create the regression curves is required, and will typically require about 50 pieces to map out the heat treatment patterns required for the misalignment values. Establishment of the heat treatment patterns is determined by trial and error and from a user's knowledge acquired from developing previous heat treatment patterns for other suspensions.

If data exists for a suspension, initial set-up and calibration may be required prior to a production run.

What is claimed is:

1. A system for measuring and adjusting the roll and pitch angles of a suspension for a magnetic disk drive, the suspension having flexure arms comprising:
a linear advancement sub-system for advancing successive suspensions to a measurement and adjustment position;
a measurement sub-system for determining the roll and pitch angle of the flexure arms;
an adjustment sub-system for mechanically bending the roll and pitch angles of the flexure arms to an aligned or over-aligned position; and,
a heat treatment sub-system for applying a heat treatment to the flexure arms when in the aligned or over-aligned position.

2. A system as in claim 1 wherein the system further includes a control algorithm having a database of heat treatment parameters for instructing the heat treatment system to apply a specific heat treatment to the flexure arms in the aligned or over-aligned position.

3. A system as in claim 1 wherein the control algorithm selects a specific heat treatment on the basis of measured roll and pitch angles.

4. A system as in claim 1 wherein the control algorithm selects specific alignment coordinates for the aligned or over-aligned position on the basis of measured roll and pitch angles.

5. A system as in claim 1 wherein the control algorithm includes a database of alignment or over-alignment position coordinates matched to specific measured roll and pitch angles.

6. A system as in claim 1 wherein the control algorithm enables adjustment of the beat treatment, alignment or over-alignment coordinates for a series of suspensions based on post heat treatment measurements of a suspension.

7. A system as in claim 1 wherein the adjustment system includes four needle probes for applying a bending force to the suspension to move the suspension to the aligned or over-aligned position.

8. A system as in claim 1 wherein the adjustment system includes four gripper arms for applying a bending force to the suspension to move the suspension to the aligned or over-aligned position.

9. A system as in claim 1 wherein the heat treatment system includes a laser that applies a heat treatment in the heat treatment zone according to predetermined laser parameters selected from length, width, laser power and time.

10. A system as in claim 9 wherein the length is 1-2 mm.

11. A system as in claim 9 wherein the width is 0.5-1 mm.

12. A system as in claim 9 wherein the laser power is 0.9-11W.

13. A system as in claim 1 wherein the control algorithm allows the flexure arms to cool for 0.5-1 s before release.

14. A system as in claim 1 wherein the control algorithm determines both overbend and backbend coordinates.

15. A method of adjusting the roll and pitch angles of a suspension for a magnetic reader for a disk drive, the suspension having flexure arms comprising the steps of
a. measuring the pitch and roll angle of the flexure arms;
b. determining if the measured pitch and roll angles of the flexures are within a pre-determined specification;
c. bending the suspension to an adjusted position if the pitch and/or roll angle of the flexure arms is/are out of specification;
d. holding the flexure arms in the adjusted position and applying a heat treatment to the flexure arms to relieve bending stresses in the flexure arms; and,
e. holding the flexure arms in the adjusted position for a time sufficient to allow the flexure arms to cool.

16. A method as in claim 15 further comprising the step of re-measuring the pitch and roll angles of the flexure arms to determine if the flexure arms are with the pre-determined specification.
